(19) United States
(12) Patent Application Publication
(10) Pub. No.: US 2017/0277678 A1
(43) Pub. Date: Sep. 28, 2017

(54) DOCUMENT CROWDSOURCED PROOFREADING SYSTEM AND METHOD

(71) Applicant: John R Ganim, Cincinnati, OH (US)

(72) Inventor: John R Ganim, Cincinnati, OH (US)

(73) Assignee: Document Crowdsourced Proof Reading, LLC, Cincinnati, OH (US)

(21) Appl. No.: 15/466,906

(22) Filed: Mar. 23, 2017

Related U.S. Application Data
(60) Provisional application No. 62/312,561, filed on Mar. 24, 2016.

(51) Int. Cl. G06F 17/27; G06F 17/24; G06F 17/30; G06F 3/0481

(52) U.S. Cl. CPC G06F 17/273; G06F 3/0481; G06F 17/24; G06F 17/30312; G06F 17/30345; H04L 69/324

(57) ABSTRACT

A document crowdsourced proofreading system and method are disclosed that includes enabling a user to activate the system when the user identifies a potential error in a document, and to select a portion of the document containing the potential error. The system also determines the author of the document, and generates a potential error message to be sent to the identified author. A proofreading database maintains records of previously identified potential errors. The system determines if the potential error has previously been reported to the author by using the proofreading database. If the potential error has not previously been reported to the author, the system sends the potential error message to the author, and records in the proofreading database that the potential error in the document has been reported to the author. The system can send the error message to the author using a messaging system of the computing environment.

### CROSS-REFERENCE TO RELATED APPLICATIONS

This application claims priority to U.S. Provisional Patent Application Ser. No. 62/312,561, filed Mar. 24, 2016 entitled “DOCUMENT CROWDSOURCED PROOFREADING SYSTEM AND METHOD;” the disclosure of which is expressly incorporated herein by reference.

### FIELD OF THE DISCLOSURE

The present disclosure relates to document proofreading systems and methods, and in particular to a system and method for document proofreading by multiple users accessing a common networked information system.

### BACKGROUND

When authors generate documents it is likely that they will periodically make mistakes in the document. The mistakes can be unintentional, due to misunderstanding, or for other reasons. In addition, speech recognition systems are being used more extensively and they add an additional layer of potential errors in the newly generated documents. Authors often have trouble proofreading their own documents because they sometimes skip over errors because they know what they mean without carefully reading the words they wrote. It is difficult to contemporaneously proofread one's own composition.

For these and other reasons, it is beneficial to have a proofreading system where a reader that reads a document can report potential errors to the author. It is most likely that a reader will carefully read a document and be interested in reporting a potential error if the document is something that they use/deal-with in their normal course of business. If the proofreading system makes it cumbersome or time-consuming for a reader to report an error, the reader is unlikely to report an error. If the system reports the error multiple times to an author and the author is inundated with error messages, the author is likely to ignore the error messages and not attempt to determine if there is an actual error and correct it (error fatigue, warning fatigue).

It would be desirable to have a proofreading system that allows a user reviewing a document in their normal course of business to quickly and easily report a potential error in the document to the author. It would be desirable to have the proofreading system determine whether the potential error has previously been reported to the author, and not report redundant errors.

### SUMMARY

A document crowdsourced proofreading system can facilitate the notification of an author, by a reader, about a potential error in a document created by the author. A document crowdsourced proofreading system can simplify and shorten the normally cumbersome process of identifying a potential error in a document and alerting the author about the potential error. The system can help prevent the sending of multiple redundant messages regarding the same error to the author. The system can include a copy of the text in question within the body of the message reporting the potential error to help the author quickly assess the need to edit the original document. The system can include a link to the original document to aid the author in navigating to the original document for review and/or edit. The system can run within an institution's secure network infrastructure, eliminating the need for any additional credentialing or security measures. The system can utilize an institution's internal messaging system to provide any necessary privacy or security. The system can collect data relating to the frequency of use of the proofreading system, the number of errors identified, the number of changes made to original documents after notification, the number of errors identified per author, the number of errors identified per reader, and/or other desired information. The system can be tailored to work with a variety of devices, operating environments, platforms, software, and network infrastructures.

A document crowdsourced proofreading system is disclosed for use in a computing environment with a plurality of electronic devices that communicate over a system network and store data in one or more system databases accessible over the system network. The plurality of electronic devices can include author devices and reader devices where the same electronic device can function as both an author device and a reader device. The document proofreading system includes an activation mechanism, an error identification tool, an author determination module, a potential error message generator, a proofreading database and a redundancy checker. The activation mechanism enables a user to activate the document proofreading system on a reader device when the user identifies a current potential error in a document created by an author. The error identification tool enables the user to select a portion of the document on the reader device where the selected portion of the document contains the current potential error. The author determination module determines the author of the document. The potential error message generator generates a potential error message to be sent to the author identified by the author determination module. The proofreading database maintains records of previously identified potential errors that were identified through the document proofreading system. The redundancy checker accesses the proofreading database to determine if the current potential error has previously been reported to the author. If the redundancy checker determines that the current potential error has not previously been reported to the author, the proofreading system sends the potential error message to the author, and records in the proofreading database that the current potential error in the document has been reported to the author.

The error identification tool can open a proofreading window on the reader device and enable the user to paste the selected portion of the document into the proofreading window. The potential error message generator can include the proofreading window in the potential error message. The potential error message generator can include a link to the document in the potential error message. The error identification tool can also collect information regarding the user and the document. The author determination module can search the document and the one or more system databases to determine the author of the document. The author determination module can ask the user to identify the author of the document. The computing environment can also include a messaging system, and the proofreading system can send the potential error message to the author using the messaging system of the computing environment.

The redundancy checker can search the records of previously identified potential errors in the proofreading database, and for each of the previously identified potential errors for the document the redundancy checker can calculate a similarity measure between the current potential error and the previously identified potential error. The redundancy checker can determine that the current potential error has not previously been reported to the author if none of the calculated similarity measures exceed a redundancy threshold. If the redundancy checker determines that the current potential error has previously been reported to the author, the proofreading system can notify the user that the current potential error has been reported to the author, and record in the proofreading database that the current potential error in the document was not reported to the author.

The document crowdsourced proofreading system can also include a reporting function that gathers information regarding each of the potential errors identified through the document proofreading system, and generates reports regarding usage of the document proofreading system.

A document crowdsourced proofreading method is disclosed that can be implemented in a non-transitory computer readable medium comprising one or more programs configured to be executed by one or more processors. The document crowdsourced proofreading method can be used in a computing environment with a plurality of electronic devices that communicate over a system network and store data in one or more system databases accessible over the system network. The plurality of electronic devices can include author and reader devices, where some electronic devices can function as either or both author and reader devices. The document proofreading method includes enabling a user to activate the document proofreading system on a reader device when the user identifies a current potential error in a document created by an author; enabling the user to identify the current potential error by selecting a portion of the document on the reader device where the selected portion of the document contains the current potential error; determining the author of the document; generating a potential error message to be sent to the author identified by the author determination module; maintaining records of previously identified potential errors that were identified through the document proofreading system in a proofreading database; and determining if the current potential error has previously been reported to the author by using the records of previously identified potential errors in the proofreading database. If it is determined that the current potential error has not previously been reported to the author, the document proofreading method can also include sending the potential error message to the author and recording in the proofreading database that the current potential error in the document has been reported to the author.

The potential error message can include the selected portion of the document containing the current potential error and a link to the document. The document crowdsourced proofreading method can also include collecting information regarding the user, and storing the collected information regarding the user in the proofreading database. Determining the author of the document can include searching the document and the one or more system databases to determine the author of the document, and if the author is not uniquely determined after the searching step, asking the user to identify the author of the document.

Determining if the current potential error has previously been reported to the author can include searching the records of previously identified potential errors in the proofreading database to determine if any of the previously identified potential errors are for the document; and for each of the previously identified potential errors for the document can also include calculating a similarity measure between the current potential error and the previously identified potential error; and determining that the current potential error has previously been reported to the author if the similarity measure exceeds a redundancy threshold. If none of the similarity measures for the current potential error exceeds the redundancy threshold, the proofreading method can also include determining that the current potential error has not previously been reported to the author. If none of the records of previously identified potential errors in the proofreading database are for the document, the proofreading method can also include determining that the current potential error has not previously been reported to the author. Calculating a similarity measure between the current potential error and the previously identified potential error can include identifying a current character string in the portion of the document selected by the user for the current potential error, identifying a previous character string in the previously identified potential error, determining a longest common substring between the current character string and the previous character string, and calculating the similarity measure as the string length of the longest common substring divided by the shorter of the string length of the current character string and the string length of the previous character string. Alternatively, calculating a similarity measure between the current potential error and the previously identified potential error can include identifying current document fields in the portion of the document selected by the user for the current potential error, determining number of document fields in the current document fields, identifying previous document fields in the previously identified potential error, determining number of document fields in the previous document fields, determining number of common fields between the current document fields and the previous document fields, and calculating the similarity measure as the number of common fields divided by the lesser of the number of document fields in the current document fields and the number of document fields in the previous document fields.

If it is determined that the current potential error has previously been reported to the author, the document crowdsourced proofreading method can also include notifying the user that the current potential error has been reported to the author, and recording in the proofreading database that the current potential error in the document was not reported to the author. The document crowdsourced proofreading method can also include gathering information regarding each of the potential errors identified through the document proofreading system, and generating reports regarding usage of the document proofreading system.

### BRIEF DESCRIPTION OF THE DRAWINGS

The above-mentioned aspects of the present disclosure and the manner of obtaining them will become more apparent and the disclosure itself will be better understood by reference to the following description of the embodiments of the disclosure, taken in conjunction with the accompanying drawings, wherein:

FIG. 1 illustrates a method for an exemplary embodiment of a crowdsourced proofreading system;

FIG. 2 illustrates interaction of components for the exemplary embodiment of the crowdsourced proofreading system in an exemplary operating environment;

FIG. 3 illustrates an exemplary potential error message;

FIG. 4 illustrates a possible computing environment for a document crowdsourced proofreading system comprising several computer systems coupled together through a network; and

FIG. 5 illustrates an exemplary architecture of an electronic device that can be used as a client computing device.

Corresponding reference numerals are used to indicate corresponding parts throughout the several views.

### DETAILED DESCRIPTION

The embodiments of the present disclosure described below are not intended to be exhaustive or to limit the disclosure to the precise forms in the following detailed description. Rather, the embodiments are chosen and described so that others skilled in the art may appreciate and understand the principles and practices of the present disclosure.

A document crowdsourced proofreading system can facilitate the notification of an author, by a reader, about a possible error in a document created by the author. A document crowdsourced proofreading system can enable some or all of the following features. The system can transform the normally cumbersome process of identifying an error in an electronic document and alerting the author of the document about the potential error into a simple and efficient process. The system can utilize the power, efficiency, and cost-effectiveness of crowdsourcing. The system can help prevent multiple redundant messages regarding a single error from being sent to author. The system can include a copy of the text in question within the body of the communication to help the author assess the need to edit the original document. The system can include a link to the original document to aid the author in navigating to the original document for review and/or edit. The system can run within an institution's secure network infrastructure, eliminating the need for any additional credentialing or security measures. The system can utilize an institution's internal messaging system to provide any necessary privacy or security. The system can collect data relating to the frequency of use of the proofreading system, the number of errors identified, the number of changes made to original documents after notification, the number of errors identified per author, the number of errors identified per reader, and/or other desired information. The system can be tailored to work with a variety of devices, operating environments, platforms, software, and network infrastructures.

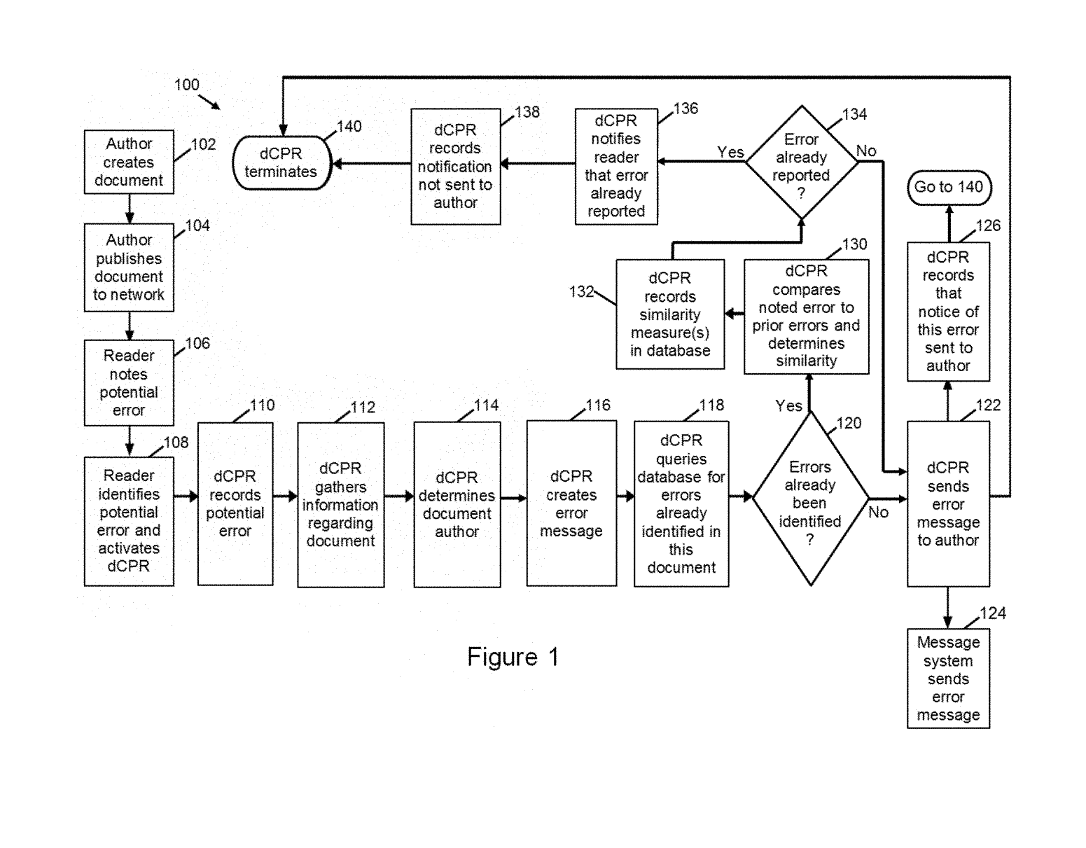

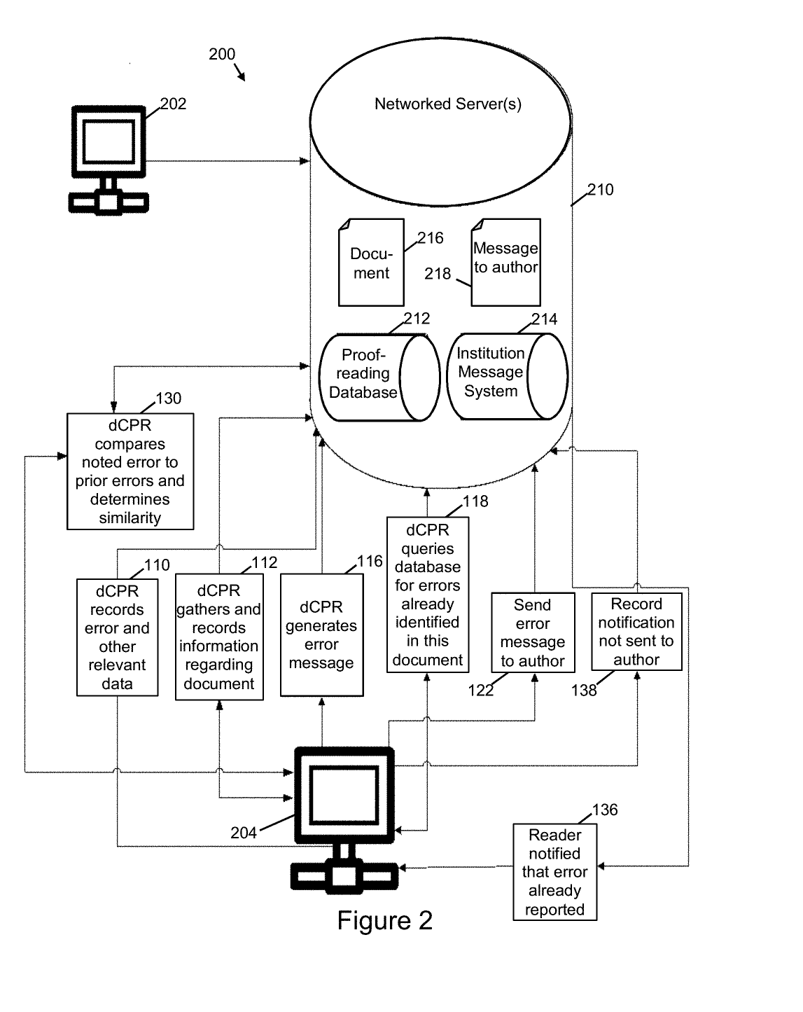

FIG. 1 illustrates a method 100 for an exemplary embodiment of a crowdsourced proofreading system. FIG. 2 illustrates interaction of components for the exemplary embodiment of the crowdsourced proofreading system in an exemplary operating environment 200. The operating environment 200 can be an institution's networked information system including one or more networked servers connected over a local or wide-area network, which can include the Internet, to one or more computers and/or other electronic devices. The institution's networked information system can include wired or wireless connection/access between the servers, computers and/or other electronic devices. FIG. 2 illustrates a portion of an institution's information system showing an author electronic device 202 and a reader electronic device 204 connected to a network server 210, where the network server 210 stores or contains a proofreading database 212 and an institution messaging system 214. Of course, the proofreading database 212 and the institution messaging system 214 can be stored or distributed across multiple networked servers.

At block 102 an author creates an electronic document 216 using the author electronic device 202. At block 104 the author stores the electronic document 216 in the network server 210. The electronic document 216 can be any of various documents stored in an institution's information system. In a healthcare environment, the electronic document 216 could be shared/accessed between physicians, nurses, specialists, other health care providers, quality coordinators, billers, auditors or other parties. In a law firm environment, the electronic document 216 could be shared/accessed between attorneys, paralegals, assistants, clients, clerks or other parties. In a law enforcement environment, the electronic document 216 could be shared/accessed between arresting officers, assisting officers, jailors or other parties. In a business environment, the electronic document 216 could be shared/accessed between team members, assistants, personnel or other parties.

At block 106 a reader reads the electronic document 216 on a reader electronic device 204. The reader is not necessarily looking for errors in the electronic document 216, but may be simply viewing the electronic document 216 as part of normal business activities. At block 108 the reader activates the document proofreading system (dCPR) and identifies a potential error in the document 216. The reader can identify the potential error by highlighting the relevant text or fields on the reader device 204 and hitting a hot key that activates the proofreading system. Alternatively, the reader can activate the proofreading system to open a window and the reader can copy the relevant text or fields in the document 216 displayed on the reader device 204, paste that relevant text or fields into the window of the proofreading system, and submit the pasted information to the proofreading system. Of course, other methods known to those of skill in the art can be used for identifying the potential error to the proofreading system. The reader can also include a note for the author regarding the potential error.

At block 110, the proofreading system records the potential error locally and writes the potential error in a proofreading database. The proofreading system can also record other relevant information in the proofreading database, for example reader reporting error, location where error reported, date and time reported, etc. At block 112, the proofreading system gathers relevant information regarding the document 216. The proofreading system can gather relevant information using metadata or other information on the institution's information system regarding the document 216. The proofreading system may process the text of the document 216 to extract relevant information relating to the document. The proofreading system may gather information including, for example, author of text, document identifier, date and time of creation. The proofreading system can record some or all of this gathered information locally and/or in the proofreading database.

At block 114, the proofreading system determines the author of the document 216. The proofreading system can use various methods to find the author including, for example, querying the metadata associated with the document or the selected text, searching the document 216 or the institution's information system for context or cues which identify an author/owner, using a natural language processing routine to analyze text for proper names and then comparing the results to a list of valid authors (for example, list of credentialed healthcare providers, firm attorneys, staff, etc.). If the proofreading system cannot identify the author, the proofreading system can notify the reader identifying the potential error and ask them to identify the author. At block 116 the proofreading system generates a potential error letter or message 218 on the network server 210. The proofreading system can generate the potential error message 218 using the existing institution messaging system 214. The error letter or message 218 can include, for example, a copy of the potential error, a link to the document containing the potential error and other relevant information. The proofreading system can present the potential error message 218, including the author to which the message is to be sent, for review and approval by the reader.

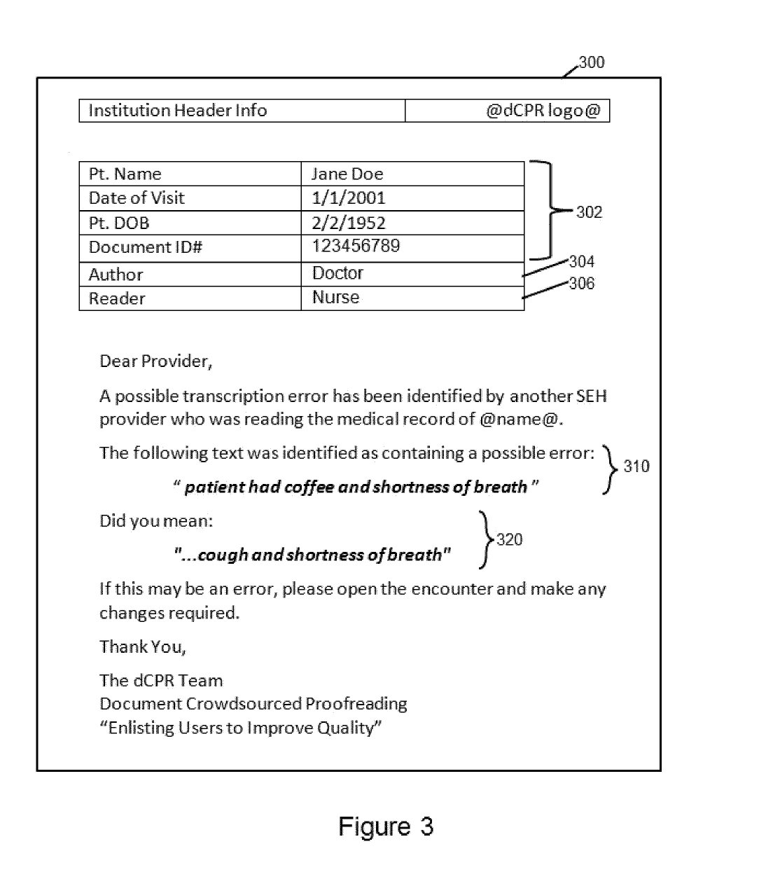

FIG. 3 illustrates an exemplary potential error message 300. The exemplary potential error message 300 includes document identifier fields 302, a document author field 304, a reader field 306, a potential error field 310 and a message to author field 320. The document identifier fields 302 can also include a link to the document. The document author field 304 can be editable by the reader, or can be editable by the reader only if the proofreading system cannot identify the author. The reader field 306 identifies the reader that identified the potential error. The potential error field 310 includes a portion of the document selected by the reader that includes the potential error. The message to author field 320 can be optional, and can include a message created by the reader to help explain the potential error. If the reader selects the Send selection 310, the proofreading system can send the error message to the author identified in the document author field 304. The proofreading system can prompt the reader to see if they want to send the potential error message 300, or go back and revise one or more of the fields, or exit out of the proofreading system without sending the potential error message 300.

At block 118 the proofreading system queries the proofreading database 212 for previously identified potential errors noted for the document 216. At block 120 the proofreading system branches depending on whether potential errors have previously been identified for the document 216. If potential errors have not previously been identified for the document 216 then control passes to block 122. If potential errors have previously been identified for the document 216 then control passes to block 130.

At block 122 the proofreading system instructs the institution messaging system 214 to send the potential error message 218 to the author identified at block 114. At block 124 the institution messaging system 214 sends the potential error message 218 as instructed by the proofreading system. At block 126 the proofreading system records in the proofreading database 212 that notification about this potential error has been sent to the author identified at block 114. After the proofreading system has instructed the institution messaging system 214 to send the potential error message 218 and recorded notification about this potential error in the proofreading database 212, the proofreading system terminates at block 140.

At block 130 the proofreading system compares the newly identified potential error to previous errors that have been reported for the document 216 and calculates a similarity measure. An example of a similarity measure is to identify the character string from the document 216 selected for the newly identified potential error, the character string identified for each previously reported error, and then determine the longest common substring. For each previously reported error, the proofreading system can then calculate the similarity measure as the length of the longest common substring divided by the length the newly identified potential error, or the length of the shorter of the newly identified and previously reported potential errors. An alternative example of a similarity measure is to identify the words/fields from the document 216 selected for the newly identified potential error, the words/fields identified for each previously reported error, and then determine the longest commonly identified words/fields. The proofreading system can then calculate the similarity measure as the length of the longest commonly identified words/fields divided by the number of words/fields in the newly identified potential error, or the number of words/fields in the shorter of the newly identified and previously reported potential errors. Of course, other methods known to those of skill in the art can be used for calculating similarity measures between the newly identified potential error and each previously reported potential error. At block 132 the proofreading system stores the calculated similarity measure of the newly identified potential error with each previously reported potential error in the proofreading database 212.

At block 134 the proofreading system branches depending on whether the similarity measure meets or exceeds some redundancy threshold indicating that the newly identified potential error is redundant with a previously reported potential error. If the similarity measure is less than the redundancy threshold then control passes to block 122 where the proofreading system will send a notification regarding the newly identified potential error. If the similarity measure is greater than or equal to the redundancy threshold then control passes to block 136.

At block 136 the proofreading system notifies the reader on the reader device 204 that the potential error has already been reported to the author. At block 138 the proofreading system records in the proofreading database 212 that notification about this potential error has not been sent to the author. Then the proofreading system terminates at block 140.

The proofreading system can be designed or customized to record information regarding a person reporting a potential error. The proofreading system can be designed or customized to notify the reader reporting an error that notification has been delivered, or that an error is redundant and has already been reported to the author. Data relating to the number of activations of the proofreading system, as well as specifics of each potential error report can be recorded in a database within the institution network. Reports can be generated periodically or on-demand that detail errors, authors, readers reporting errors, and other information. The reports can be generated for interested internal parties, for example quality assurance (QA), chief information officer (CIO), chief executive officer (CEO), information technology (IT). Generic reports, without personal identifying information, can also be generated and sent to an external party for statistical analysis and business reporting purposes.

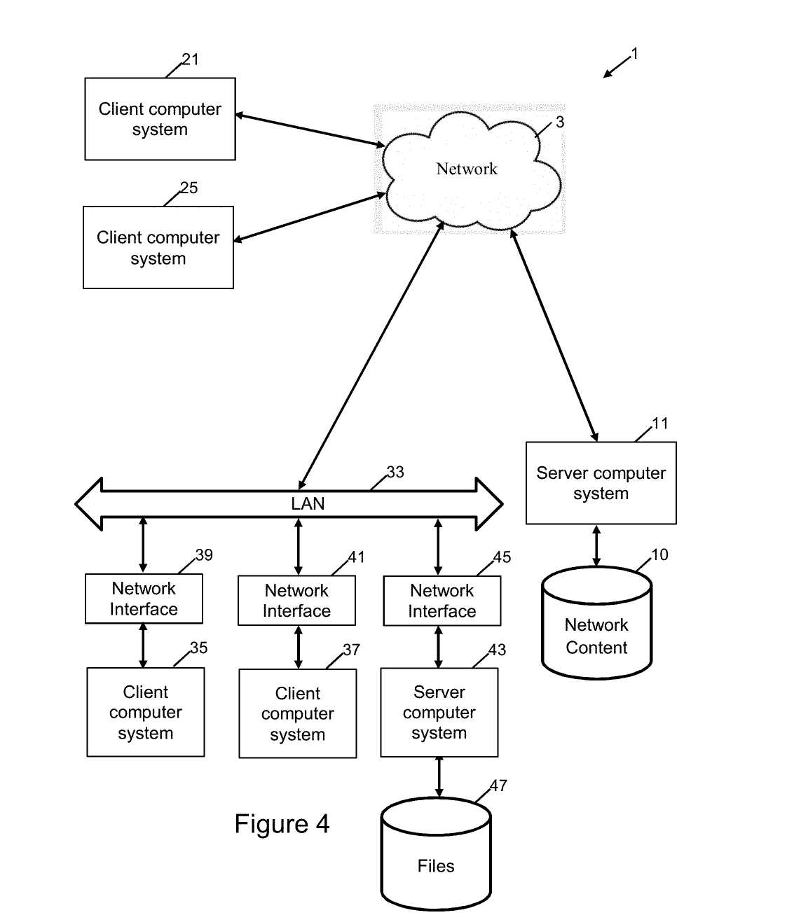

The following description of FIGS. 3 and 4 are intended to provide an overview of exemplary computer hardware and other operating components suitable for performing the methods of the invention described above. However, it is not intended to limit the applicable environments. One of skill in the art will immediately appreciate that the invention can be practiced with other computer system configurations, including hand-held devices, tablets, smart phones, multiprocessor systems, microprocessor-based or programmable consumer electronics, network PCs, minicomputers, mainframe computers, and the like. The invention can also be practiced in distributed computing environments where tasks are performed by remote processing devices that are linked through a communications network, such as a local area network (LAN), wide-area network (WAN), or over the Internet.

FIG. 4 illustrates a possible computing environment for a document crowdsourced proofreading system comprising several computer systems 1 that are coupled together through a network 3, such as the Internet. Users on client systems, such as client computer systems 21, 25, 35, and 37 can be connected to the network 3 by various types of network wired and wireless network interfaces. Access to the network 3 allows users of the client computer systems to exchange information, receive and send messages, and view documents. These documents can be stored in a network content database 10 accessible through a server computer system 11 which is connected to the network 3.

Client computer systems 21, 25, 35, and 37 can each enable a user to view, create and modify information accessible over the network 3. The author and/or user devices can be any of client computer systems 21, 25, 35, and 37. The client computer systems 21 and 25 can each be a personal computer system, a network computer, a smartphone, a tablet device, or other such electronic device. Client computer systems 35 and 37 are coupled to a local area network (LAN) 33 through network interfaces 39 and 41, which can be Ethernet network or other network interfaces. A server computer system 43 can be directly coupled to the LAN 33 through a network interface 45 to provide files 47 and other services to the client computer systems 35 and 37, without the need to connect to the network 3.

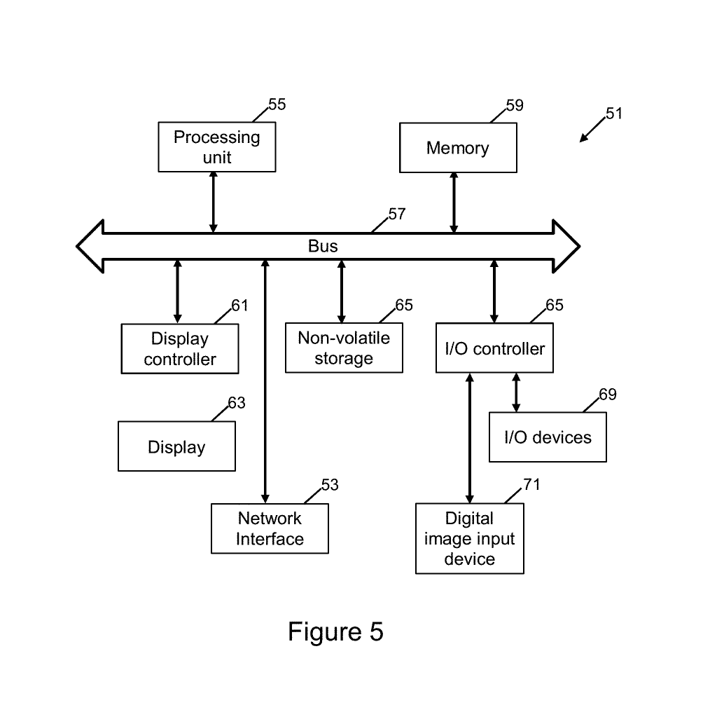

FIG. 5 illustrates an exemplary architecture of an electronic device 51 that can be used as a client computing device. The electronic device 51 can interface to external systems through a network interface 53. The computer system 51 includes a processing unit 55, memory 59 and a bus 57. The bus 57 couples the processor 55 to the memory 59 and also to non-volatile storage 65, a display controller 61 and to an input/output (I/O) controller 67. The display controller 61 controls a display 63 which can be any type of various electronic display device known in the art. The I/O controller 67 controls input/output devices 69, for example a keyboard, touchscreen, mouse, disk drives, printers, scanner, and other input and output devices. The I/O controller 67 can also control a digital image input device 71 such as a digital camera in order to allow images from the digital camera to be input into the computer system 51. It will be appreciated that the electronic device 51 is one example of many possible electronic devices which have different architectures.

The invention can be implemented in software, hardware or a combination of hardware and software. The invention can also be embodied as computer readable code on a computer readable medium where the computer readable code can include one or more programs configured to be executed by one or more processors to implement the document crowdsourced proofreading method. The method can be used in a computing environment with a plurality of electronic devices that communicate over a system network and store data in one or more system databases accessible over the system network. The plurality of electronic devices can include author devices used by authors and reader devices used by readers, where some of the electronic devices can function as both author and reader devices. The computer readable medium can be any data storage device that can store data which can thereafter be read by an electronic device. Examples of the computer readable medium include read-only memory, random-access memory, CD-ROMs, DVDs, magnetic tape, USB sticks, and optical data storage devices. The computer readable medium can also be distributed over network-coupled computer systems so that the computer readable code is stored and executed in a distributed fashion.

While the disclosure has been illustrated and described in detail in the drawings and foregoing description, such illustration and description is to be considered as exemplary and not restrictive in character, it being understood that illustrative embodiment(s) have been shown and described and that all changes and modifications that come within the spirit of the disclosure are desired to be protected. It will be noted that alternative embodiments of the present disclosure may not include all of the features described yet still benefit from at least some of the advantages of such features. Those of ordinary skill in the art may readily devise their own implementations that incorporate one or more of the features of the present disclosure and fall within the spirit and scope of the present invention.

I claim:

1. A document crowdsourced proofreading system for use in a computing environment with a plurality of electronic devices that communicate over a system network and store data in one or more system databases accessible over the system network, the plurality of electronic devices including author and reader devices, the document proofreading system comprising:
an activation mechanism that enables a user to activate the document proofreading system on a reader device when the user identifies a current potential error in a document created by an author;
an error identification tool that enables the user to select a portion of the document on the reader device, the selected portion of the document containing the current potential error;
an author determination module that determines the author of the document;
a potential error message generator that generates a potential error message to be sent to the author identified by the author determination module;
a proofreading database that maintains records of previously identified potential errors that were identified through the document proofreading system;
a redundancy checker that accesses the proofreading database to determine if the current potential error has previously been reported to the author;
wherein if the redundancy checker determines that the current potential error has not previously been reported to the author, the proofreading system sends the potential error message to the author, and records in the proofreading database that the current potential error in the document has been reported to the author.

2. The document crowdsourced proofreading system of claim 1, wherein the error identification tool opens a proofreading window on the reader device and enables the user to paste the selected portion of the document into the proofreading window.

3. The document crowdsourced proofreading system of claim 2, wherein the potential error message generator includes the proofreading window in the potential error message.

4. The document crowdsourced proofreading system of claim 3, wherein the potential error message generator includes a link to the document in the potential error message.

5. The document crowdsourced proofreading system of claim 1, wherein the error identification tool collects information regarding the user and the document.

6. The document crowdsourced proofreading system of claim 1, wherein the author determination module searches the document and the one or more system databases to determine the author of the document.

7. The document crowdsourced proofreading system of claim 6, wherein the author determination module asks the user to identify the author of the document.

8. The document crowdsourced proofreading system of claim 1, wherein the computing environment further includes a messaging system, and
wherein the proofreading system sends the potential error message to the author using the messaging system of the computing environment.

9. The document crowdsourced proofreading system of claim 1, wherein the redundancy checker searches the records of previously identified potential errors in the proofreading database, and for each of the previously identified potential errors for the document the redundancy checker calculates a similarity measure between the current potential error and the previously identified potential error; and the redundancy checker determines that the current potential error has not previously been reported to the author if none of the calculated similarity measures exceed a redundancy threshold.

10. The document crowdsourced proofreading system of claim 1, wherein if the redundancy checker determines that the current potential error has previously been reported to the author, the proofreading system notifies the user that the current potential error has been reported to the author, and records in the proofreading database that the current potential error in the document was not reported to the author.

11. The document crowdsourced proofreading system of claim 1, further comprising:
a reporting function that gathers information regarding each of the potential errors identified through the document proofreading system, and generates reports regarding usage of the document proofreading system.

12. A non-transitory computer readable medium comprising one or more programs configured to be executed by one or more processors to implement a document crowdsourced proofreading method for use in a computing environment with a plurality of electronic devices that communicate over a system network and store data in one or more system databases accessible over the system network, the plurality of electronic devices including author and reader devices, the document proofreading method comprising:
enabling a user to activate the document proofreading system on a reader device when the user identifies a current potential error in a document created by an author;
enabling the user to identify the current potential error by selecting a portion of the document on the reader device, the selected portion of the document containing the current potential error;
determining the author of the document;
generating a potential error message to be sent to the author identified by the author determination module;
maintaining records of previously identified potential errors that were identified through the document proofreading system in a proofreading database;
determining if the current potential error has previously been reported to the author by using the records of previously identified potential errors in the proofreading database;
if it is determined that the current potential error has not previously been reported to the author, sending the potential error message to the author and recording in the proofreading database that the current potential error in the document has been reported to the author.

13. The non-transitory computer readable medium of claim 12, wherein the potential error message includes the selected portion of the document containing the current potential error and a link to the document.

14. The non-transitory computer readable medium of claim 12, wherein the document crowdsourced proofreading method further comprises:
collecting information regarding the user; and
storing the collected information regarding the user in the proofreading database.

15. The non-transitory computer readable medium of claim 12, wherein determining the author of the document comprises:
searching the document and the one or more system databases to determine the author of the document; and
if the author is not uniquely determined after the searching step, asking the user to identify the author of the document.

16. The non-transitory computer readable medium of claim 12, wherein determining if the current potential error has previously been reported to the author comprises:
searching the records of previously identified potential errors in the proofreading database to determine if any of the previously identified potential errors are for the document;
for each of the previously identified potential errors for the document:
calculating a similarity measure between the current potential error and the previously identified potential error;
determining that the current potential error has previously been reported to the author if the similarity measure exceeds a redundancy threshold;
if none of the similarity measures for the current potential error exceeds the redundancy threshold, determining that the current potential error has not previously been reported to the author; and
if none of the records of previously identified potential errors in the proofreading database are for the document, determining that the current potential error has not previously been reported to the author.

17. The non-transitory computer readable medium of claim 16, wherein calculating a similarity measure between the current potential error and the previously identified potential error comprises:
identifying a current character string in the portion of the document selected by the user for the current potential error, the current character string having a string length;
identifying a previous character string in the previously identified potential error, the previous character string having a string length;
determining a longest common substring between the current character string and the previous character string, the longest common substring having a string length; and
calculating the similarity measure as the string length of the longest common substring divided by the shorter of the string length of the current character string and the string length of the previous character string.

18. The non-transitory computer readable medium of claim 16, wherein calculating a similarity measure between the current potential error and the previously identified potential error comprises:
identifying current document fields in the portion of the document selected by the user for the current potential error;
determining number of document fields in the current document fields;
identifying previous document fields in the previously identified potential error;
determining number of document fields in the previous document fields;
determining number of common fields between the current document fields and the previous document fields; and
calculating the similarity measure as the number of common fields divided by the lesser of the number of document fields in the current document fields and the number of document fields in the previous document fields.

19. The non-transitory computer readable medium of claim 12, wherein the document crowdsourced proofreading method further comprises:
if it is determined that the current potential error has previously been reported to the author, notifying the user that the current potential error has been reported to the author, and recording in the proofreading database that the current potential error in the document was not reported to the author.

20. The non-transitory computer readable medium of claim 12, wherein the document crowdsourced proofreading method further comprises:
gathering information regarding each of the potential errors identified through the document proofreading system; and
generating reports regarding usage of the document proofreading system.
